(19) United States
(12) Patent Application Publication
(10) Pub. No.: US 2005/0066753 A1
(43) Pub. Date: Mar. 31, 2005

(54) Testing assembly for reducing noise emitted from a random vibration apparatus

(76) Inventor: Gregory S. Leger, Colorado Springs, CO (US)

Correspondence Address: Emery L. Tracy, P. O. Box 1518, Boulder, CO, 80306-1518, US

(21) Appl. No.: 10/953,996

(22) Filed: Sep. 29, 2004

Related U.S. Application Data
(60) Provisional application No. 60/507,370, filed on Sep. 30, 2003.

(51) Int. Cl. G01M 7/02

(52) U.S. Cl. 73/865.6; 73/663

(57) ABSTRACT

A testing assembly for reducing noise emitted from a random vibration apparatus is provided. The testing assembly comprises a base assembly and a cover assembly hingedly connected to the base assembly. At least one inner base positioned within the base assembly with each inner base having at least one aperture. A vibration testing table is secured within the inner base. At least one vibration mechanism is secured within the inner base and communicates with the vibration testing table.

The present application is a continuation of pending provisional patent application Ser. No. 60/507,370, filed on Sep. 30, 2003, entitled “System and Method for Reducing Noise Emitted from a Random Vibration Apparatus”.

### BACKGROUND OF THE INVENTION

1. Field of the Invention

The present invention relates to a random vibration apparatus for severely stressing other devices under a broad range of frequencies and conditions and, more particularly, it specifically relates to reducing noise emitted from such devices in which the reduction in noise is accomplished by the use of a muffling chamber, apertures, and double wall construction below the pneumatic hammers, which are the main source of the emitted noise.

2. Description of the Prior Art

Chambers of a standalone vibration apparatus are enclosed in large thick wall heavily insulated units or left open. The noise level of the open units is easily above 90 db and is kept away from work areas. Most units that are enclosed are very expensive to enclose with layers of insulation, metal, and/or multiple panes of thick glass or other transparent material.

Accordingly, there exists a need for a system and method for reducing the emitted sound when operating a vibration apparatus. Additionally, a need exists for a system and method which is has a smaller and lighter enclosure for the apparatus. Furthermore, there exists a need for combining the three improvements making the use of such an apparatus more widespread, allowing it to be easily portable, and usable in many environments where such apparatus were not suitable due to size, noise level, or difficulty in transporting the apparatus.

### SUMMARY

The present invention is a testing assembly for reducing noise emitted from a random vibration apparatus. The testing assembly comprises a base assembly and a cover assembly hingedly connected to the base assembly. At least one inner base is positioned within the base assembly with each inner base having at least one aperture. A vibration testing table is secured within the inner base. At least one pneumatic hammer is secured within the inner base and communicates with the vibration testing table.

The present invention further includes an enclosure for receiving a vibration testing table and at least one pneumatic hammer with a device to be tested positionable upon the vibration testing table. The enclosure comprises a multi-layered base assembly and a multi-layered cover assembly positionable upon the base assembly. A receiving container is positionable within the base assembly with the vibration testing table and the pneumatic hammer receivable within the receiving container. A plurality of apertures formed in the container.

The level of emitted sound by the system and method of the present invention is reduced by the application of a muffling area under or above the table. Apertures formed in the interior enclosure allow sound waves to reflect and enter into the muffling area.

### BRIEF DESCRIPTION OF THE DRAWINGS

FIG. 1 is a perspective view illustrating a vibration unit, constructed in accordance with the present invention;

FIG. 2 is an exploded perspective view illustrating the base lower unit of the vibration unit of FIG. 1, constructed in accordance with the present invention;

FIG. 3 is an exploded perspective view illustrating the cover of the vibration unit of FIG. 1, constructed in accordance with the present invention;

FIG. 4 is an exploded perspective view illustrating the table of the vibration unit of FIG. 1, constructed in accordance with the present invention; and

FIG. 5 is an exploded perspective view illustrating the pneumatic hammer of the vibration unit of FIG. 1, constructed in accordance with the present invention.

### DETAILED DESCRIPTION OF THE PREFERRED EMBODIMENTS

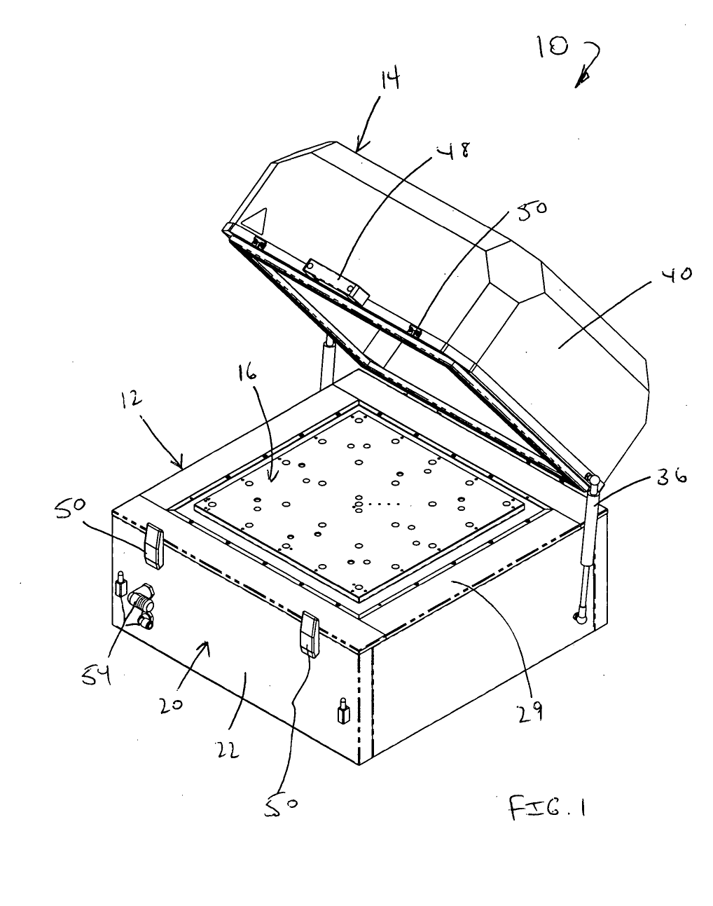

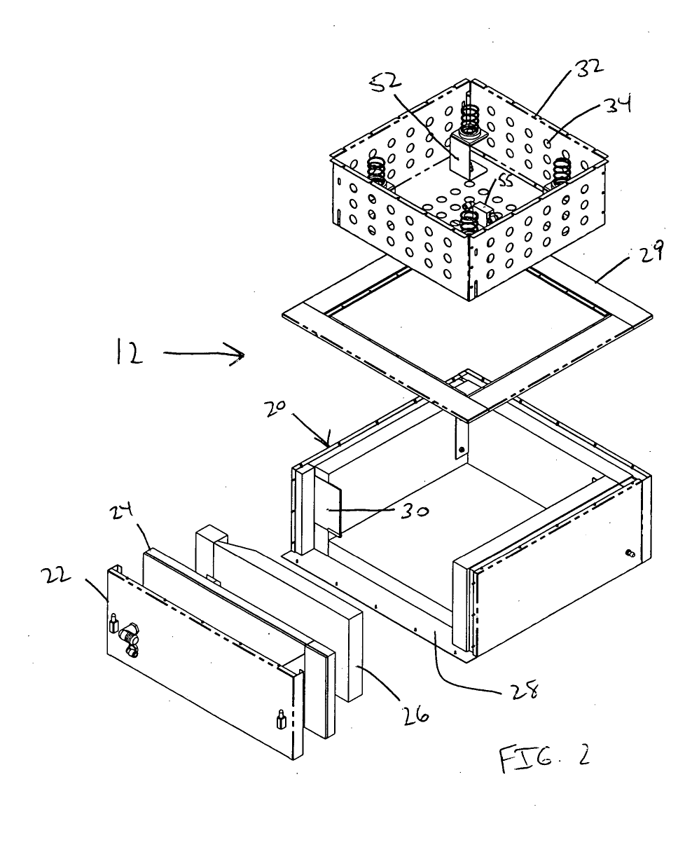

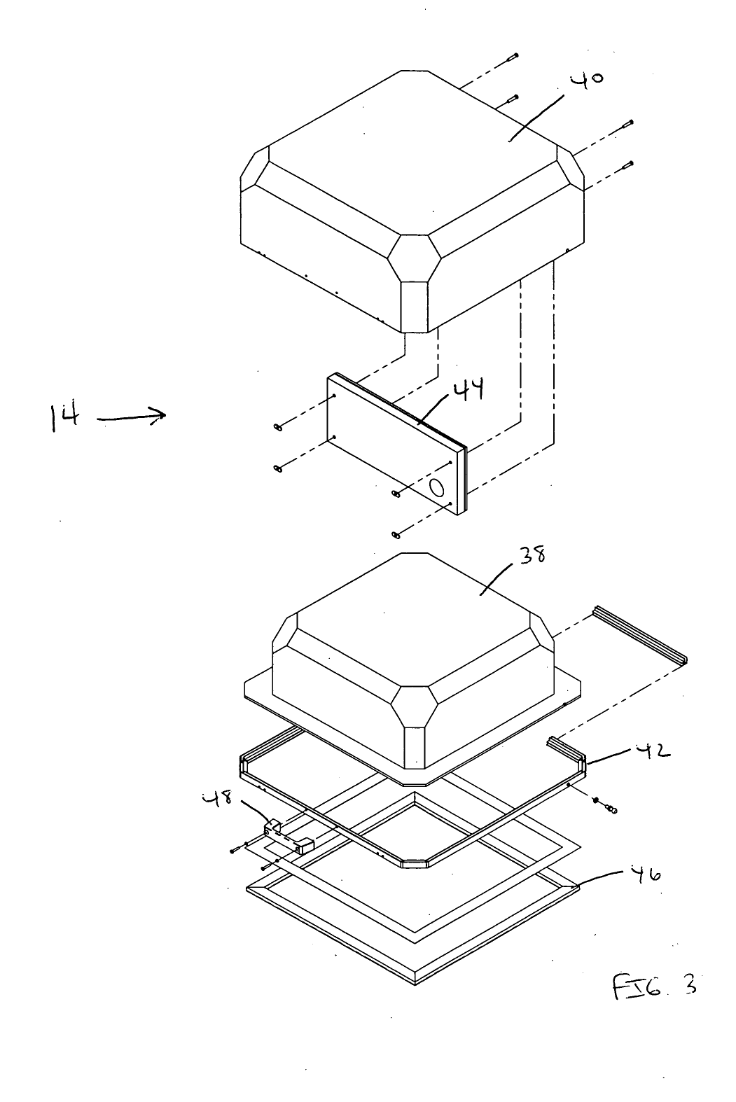

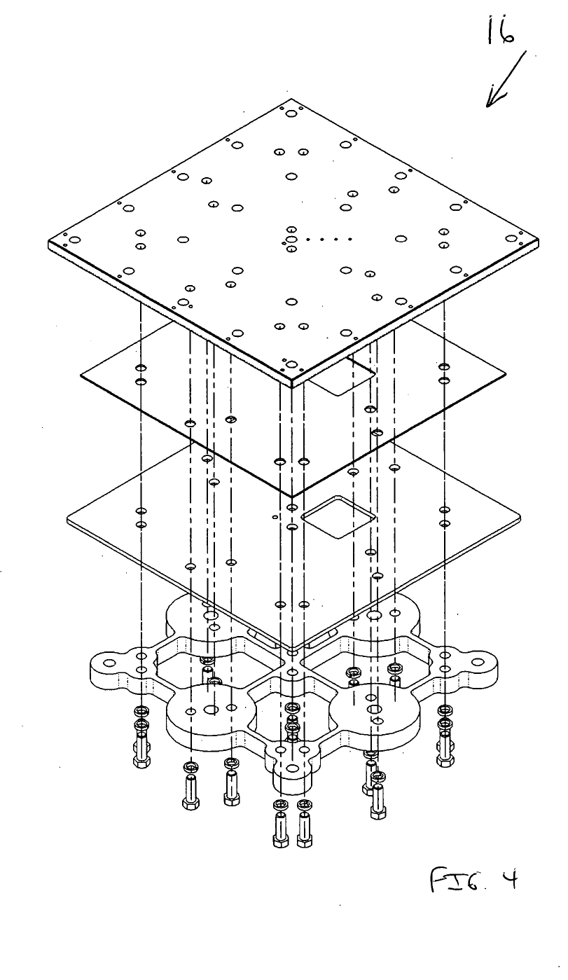

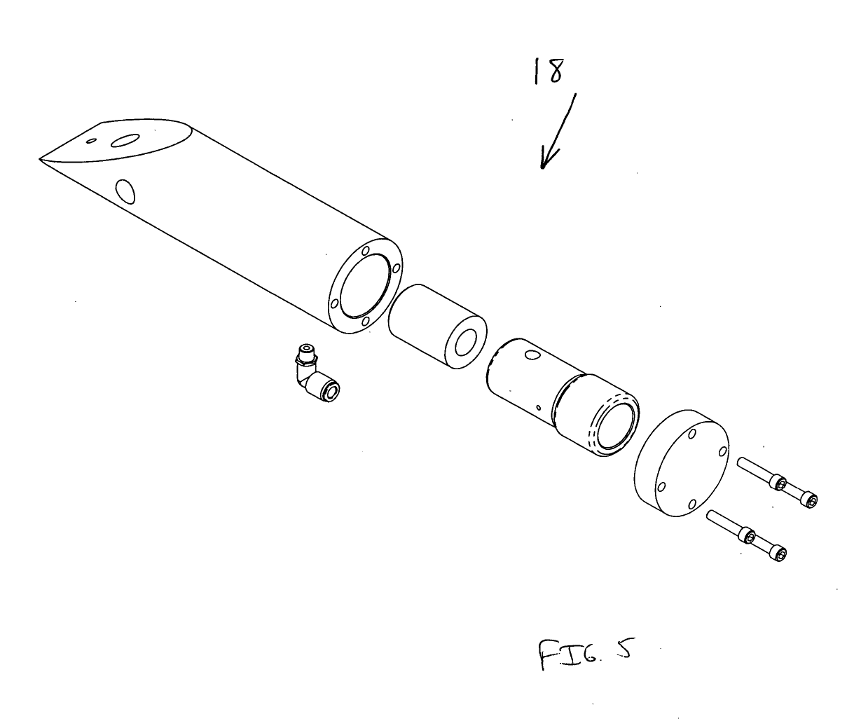

As illustrated in FIGS. 1-5, the present invention is a testing assembly, indicated generally at 10, for reducing the sound level from a vibration apparatus. In accordance with the present invention, the testing assembly 10 is a six-sided enclosure (as illustrated in FIG. 1) having an exterior wall and a separate interior wall is provided. The testing assembly 10 includes three main assemblies, namely, a base assembly 12 (as illustrated in FIG. 2), a cover assembly 14 (as illustrated in FIG. 3), and a vibration apparatus table 16 (as illustrated in FIG. 4). A pneumatic hammer or other vibration means 18 (as illustrated in FIG. 5) drives the vibration apparatus table 16 in a known manner.

The base assembly 12 of the testing assembly 10 of the present invention includes a plurality of side walls 20 with each side wall 20 having an outer side wall 22, a middle side wall 24, and an inner side wall 26. A bottom plate 28 is secured to the side walls 20. Preferably, the outer side wall 22 is constructed from a sheet metal material, the middle side wall 24 is constructed from a foam material, the inner side wall 26 is constructed from a high density vinyl material, and the bottom plate 28 is constructed from a sheet metal material. It should be noted and realized by a person skilled in the art that the outer side wall 22, the middle side wall 24, the inner side wall 26, and the bottom plate 28 can be constructed from different materials.

The outer side walls 22 of the base assembly 12 are preferably secured to the bottom wall 28 and each other. The middle side walls 24 and inner side walls 26 are sandwiched between the outer side walls 22 and the interior side walls 32. A trim piece 29 connects the side walls 20 and the interior side walls 32 together.

The base assembly 12 of the testing assembly 10 further includes at least one removable interior wall 32 preferably have at least one aperture 34 such that one to all of the interior walls 32 have singular to multiple apertures 34 or cutouts to reduce emitted sound level from the testing assembly 10. The interior side walls 32 are secured to each other and secured by a plurality of brackets 30 to the outer side walls. Preferably, the interior wall 32 of the base assembly 12 is constructed from a sheet metal material, however, constructing the interior wall 32 from other materials is within the scope of the present invention.

As illustrated in FIG. 3, the cover assembly 14 of the testing assembly 10 of the present invention is hingedly connected to the base assembly 12 by a pair of hinges and pressurized gas springs 36. The cover assembly 14 has an inner wall 38 and an outer wall 40. Both the inner wall 38 and the outer wall 40 of the cover assembly 14 are preferably constructed from a clear plexiglas material although constructing the cover assembly 14 from other materials is within the scope of the present invention. The clear material, however, allows a user to view the testing being conducted within the testing assembly 10.

The cover assembly 14 further includes a resilient gasket 46 for sealing the inside of the testing assembly 10 when the cover assembly 14 is closed onto the base assembly 12. A foam panel 44 is secured to the rear wall of the cover assembly 14 to further assist in noise reduction. At least one trim piece 42 about the periphery of the cover assembly 14 connects the inner wall 38 of the cover assembly 12 to the outer wall 40 of the cover assembly 14.

A handle 48 is mounted to the cover assembly 14 to assist in carrying the testing assembly 10. Latches 50 can also be provided on the base assembly 12 and cover assembly 14 to releasably close the base assembly 12 and cover assembly 14 together.

As illustrated in FIG. 4, a vibration testing table 16 is provided for mounting the device (not shown) to be tested. Brackets 52 mounted to the interior wall 32 of the base assembly 12 releasably secure the vibration testing table 16 to the testing assembly 10.

As illustrated in FIG. 5, a pneumatic hammer 18 provides motion to the vibrating testing table 16 mounted with the testing assembly 10. It should be noted that any type of pneumatic hammer 18 or other vibration device can be used with the testing assembly 10 of the present invention.

The base assembly 12 further includes an air inlet and air exhaust 54 for connecting air to the pneumatic hammer 18. The number and position of air manifolds 55 depends on the number of pneumatic hammers.

The advantage of the testing assembly 10 present invention is the reduction in the emitted sound when operating a vibration apparatus. Also, the testing assembly 10 allows for a much smaller and lighter enclosure for the vibration testing table 16 and pneumatic hammer 18. The combination of these three improvements makes the use of the testing assembly 10 of the present invention more widespread allowing it to be easily portable and to be used in many environments where such apparatus were not suitable due to size, noise level, or difficulty in transporting the apparatus.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. A testing assembly for reducing noise emitted from a random vibration apparatus, the testing assembly comprising:
a base assembly;
a cover assembly hingedly connected to the base assembly;
at least one inner base having positioned within the base assembly, each inner base having at least one aperture;
a vibration testing table secured within the inner base; and
at least one vibration means for vibrating the testing table, the vibration means secured within the inner base and communicating with the vibration testing table.

2. The testing assembly of claim 1 wherein the base assembly includes a base wall, an outer wall, a middle wall, and an inner wall.

3. The testing assembly of claim 2 wherein the outer wall is constructed from a sheet metal material, the middle wall is constructed from a foam material, the inner wall is constructed from a high density vinyl material, and the base wall is constructed from a sheet metal material.

4. The testing assembly of claim 2 wherein the outer walls are secured to the base wall and each other.

5. The testing assembly of claim 4 wherein the inner walls are secured to each other by a plurality of brackets and are secured to the outer side walls.

6. The testing assembly of claim 2 wherein the middle walls are sandwiched between the outer walls and the inner walls.

7. The testing assembly of claim 1 wherein the inner base is constructed from a sheet metal material.

8. The testing assembly of claim 1 and further comprising:
at least one hinge for connecting the base assembly to the cover assembly.

9. The testing assembly of claim 1 wherein the cover assembly has an inner wall and an outer wall.

10. The testing assembly of claim 9 wherein the inner wall and the outer wall are constructed from a clear plexiglas material.

11. The testing assembly of claim 1 and further comprising:
a resilient gasket between the base assembly and the cover assembly.

12. The testing assembly of claim 1 and further comprising:
a foam panel secured to a rear wall of the cover assembly.

13. The testing assembly of claim 1 and further comprising at least one trim piece about the periphery of the cover assembly connecting the inner wall to the outer wall.

14. The testing apparatus of claim 1 and further comprising:
at least one air manifold for connecting air to the vibration means.

15. An enclosure for receiving a vibration testing table and at least one pneumatic hammer, a device to be tested positionable upon the vibration testing table, the enclosure comprising:
a multi-layered base assembly;
a multi-layered cover assembly positionable upon the base assembly;
a receiving container positionable within the base assembly, the vibration testing table and the pneumatic hammer receivable within the receiving container; and
a plurality of apertures formed in the container.

16. The enclosure of claim 15 wherein the base assembly includes a base wall, an outer wall, a middle wall, and an inner wall.

17. The enclosure of claim 15 and further comprising:
at least one hinge for connecting the base assembly to the cover assembly.

18. The enclosure of claim 15 wherein the cover assembly has an inner wall and an outer wall.

19. The enclosure of claim 15 and further comprising:
a resilient gasket between the base assembly and the cover assembly.

20. The enclosure of claim 15 and further comprising:
a foam panel secured to a rear wall of the cover assembly.
